(19) United States
(12) Patent Application Publication
(10) Pub. No.: US 2026/0010545 A1
(43) Pub. Date: Jan. 8, 2026

(54) SYSTEMS AND METHODS FOR CASH FLOW SOFTWARE REGARDING REAL ESTATE DEVELOPMENT AND MANAGEMENT SOFTWARE

(71) Applicant: Northspyre, Inc., Brooklyn, NY (US)

(72) Inventors: William Sankey, Atlanta, GA (US); Tiffany Chin, Brooklyn, NY (US); Matthew Phinney, Brooklyn, NY (US)

(21) Appl. No.: 18/766,017

(22) Filed: Jul. 8, 2024

(51) Int. Cl. G06F 16/26; G06Q 10/0631; G06Q 50/16

(52) U.S. Cl. CPC G06F 16/26; G06Q 10/06315; G06Q 50/165

(57) ABSTRACT

Cloud-based systems and methods for visualizing dynamically updated data flows are disclosed, which includes inputting expected data flow defined over a set time period and generating therefrom a default graphical display depicting a default graphical curve having a graphical curve type defined by each of a predefined graphical shape as selected. A unit time period may be selected and overridden, causing the creation or generation of an augmented graphical curve defined by an overridden expected data flow. The augmented graphical curve having an updated portion visually depicting the overridden expected data flow over a time period may be generated as part of a dynamically updated graphical display for visualization on a GUI of the display screen of the client device.

### FIELD OF THE DISCLOSURE

The present disclosure generally relates to cloud-based systems and methods, and more particularly, to techniques for cloud-based systems and methods for visualizing dynamically updated data flows.

### BACKGROUND

Visualization of dynamic data is difficult especially when such data can change in real-time and occurs across a computer network where one device communicates with another to send and receive the data for visualization purposes.

Additional problems can arise where the visualization of data depends on data groups or otherwise fluctuating dynamic data, where a change in value of a data group can trigger and causes changes to all values in the data group as a whole. When such changes occur, visualization of the data can be exasperated, especially when attempting to visualize such data across a computer network, e.g., where the data is stored on a sever or cloud-based platform and the data is to be visualized on an edge device.

Still further, additional problems can arise from attempting to establish a pattern of data for a specific type of project. In such scenarios, users must manually create and update specific values across a given data pattern to make projections over a set period. What is worse is that, if there is a change of data for a given portion of the data pattern, then a user must manually update the entire data set of the data pattern in order for the system to have a basis for visualization of such data.

Accordingly, there is a need for cloud-based systems and methods for visualizing dynamically updated data flows as described herein.

### SUMMARY

Cloud-based systems and methods are described herein for visualizing dynamically updated data flows. In various aspects, the data flows are transmitted across a computer network (e.g., from a cloud-based platform) in real-time, and may be continuously adapted to implement updates and changes. For example, a user can provide an override data value to override one or more data segment(s) (e.g., unit time period(s)), which causes generation of a projection or predicted values or amounts to be determined for each data segment (e.g., unit time period) over a set time period. The newly generated projection or predicted values may then be used to generated a new pattern or otherwise data flow based on not only the updated data segment(s) but also the data segment(s) affected by the change, where the remaining data segment(s), or otherwise curve values, will automatically adjust to reflect a total amount across the entirety of set time period allowed for each of the data segment(s) as a whole. A new visualization or otherwise graphic can then be generated based on the updated or new pattern of data flow. In this way, the disclosed systems and methods allow updating (e.g., pinning) a value with static data that differs from an original modeled graphical curve across a set time period, and where the systems and methods can then visualize a new curve, or otherwise update the existing curve, to auto-fit around the updated data segment(s).

In one example, a data flow may be related to a cash flow or a project budget, where each data segment relates cash expenditures expected for a given data segment, e.g., as unit of time such as month. In such an example, a GUI may generate visualizations of forward-looking projections or otherwise predictions of a project's budget and spending that dynamically update as data (e.g., invoices) are accepted and as budgets change. Using the total committed budget and predicted end date of a project, users can update and project a spending curve for costs across the project budget. Users can update data flow at a level of granularity of a single data segment (e.g., unit of time), which, once updated, can be distributed across an overall projected spending total for a given project, e.g., a real estate development project. Other examples may include tracking and updating a data flow related to energy use of U.S. households over a 24-hour period, 1 year period, or other time periods.

Accordingly, in some aspects, the techniques described herein relate to a cloud-based system for visualizing dynamically updated data flows, the cloud-based system including: one or more processors accessible over a computer network; one or more memories communicatively coupled with the one or more processors, the one or more memories storing a set of predefined graphical shapes, each predefined graphic shape defining a graphical curve type of an expected data flow; and computer executable instructions stored in the one or more memories that, when executed by the one or more processors, cause the one or more processors to: input an expected data flow defined over a set time period; generate a selection display depicting each of the predefined graphical shapes, the selection display configured for visualization on a graphic user interface (GUI) of a display screen of a client device; receive a selection of a predefined graphical shape as selected from the predefined graphical shapes, generate, based on the selection of the predefined graphical shape, a default graphical display depicting a default graphical curve having by a graphical curve type defined by each of: (a) the predefined graphical shape as selected, and (b) the data flow defined over the set time period, the default display configured for visualization on the GUI of the display screen of the client device, receive a selection of a unit time period selected from within the set time period, the unit time period displayed on the default graphical display, receive an override data value for overriding the expected data flow, the override data value defined for the unit time period as selected from within the set time period, generate an overridden expected data flow defined over the set time period by updating the expected data flow with the override data value, dynamically update the default graphical curve to create an augmented graphical curve defined by the overridden expected data flow, generate, based on the augmented graphical curve, a dynamically updated graphical display depicting the augmented graphical curve having an updated portion visually depicting the overridden expected data flow over the set time period, the dynamically updated graphical display configured for visualization on the GUI of the display screen of the client device.

In some aspects, the techniques described herein relate to a cloud-based system, wherein the computer executable instructions, when executed by the one or more processors, further cause the one or more processors to: transmits each of the selection display, the default display, and the dynamically updated graphical display to the client device over the computer network; and receive each of the selection and the override data value from the client device over the computer network.

In some aspects, the techniques described herein relate to a cloud-based system, wherein the computer executable instructions, when executed by the one or more processors, further cause the one or more processors to: set as statically defined the override data value within overridden expected data flow defined over the set time period.

In some aspects, the techniques described herein relate to a cloud-based system, wherein the computer executable instructions, when executed by the one or more processors, further cause the one or more processors to: generate, as part of a display, a graphical element indicating that the override data value is a statically defined value within the overridden expected data flow.

In some aspects, the techniques described herein relate to a cloud-based system, wherein the computer executable instructions, when executed by the one or more processors, further cause the one or more processors to: convert the overridden expected data flow of the augmented graphical curve into a data flow graph having a converted curve data format, store the data flow graph into a database, load the data flow graph from the database, and regenerate, based on the data flow graph from the database, the dynamically updated graphical display depicting the augmented graphical curve having the updated portion visually depicting the overridden expected data flow over the set time period, the dynamically updated graphical display configured for visualization on the GUI of the display screen of the client device.

In some aspects, the techniques described herein relate to a cloud-based system, wherein the converted curve data format includes a compressed data format stored in a single non-denormalized column of the database.

In some aspects, the techniques described herein relate to a cloud-based system, wherein one or more portions of the expected data flow are received in a plurality of different formats when analyzed by the one or more processors, and the computer executable instructions, when executed by the one or more processors, further cause the one or more processors to: convert the one or more portions of the expected data flow to a normalized format.

In some aspects, the techniques described herein relate to a cloud-based system, wherein the normalized format includes a JavaScript Object Notation (JSON) format.

In some aspects, the techniques described herein relate to a cloud-based system, wherein upon or as part of generation of the overridden expected data flow, the computer executable instructions, when executed by the one or more processors, further cause the one or more processors to: update one or more remaining data values other than the override data value within the overridden expected data flow defined over the set time period, wherein the augmented graphical curve is created to graphically depict each of the override data value and the one or more remaining data values, each as updated in the overridden expected data flow as triggered by a change in the override data value.

In some aspects, the techniques described herein relate to a cloud-based method for visualizing dynamically updated data flows, the cloud-based method including: inputting, by one or more processors accessible over a computer network, an expected data flow defined over a set time period; generating, by the one or more processors, a selection display depicting each of a set of predefined graphical shapes, the selection display configured for visualization on a graphic user interface (GUI) of a display screen of a client device, each predefined graphic shape defining a graphical curve type of an expected data flow; receiving, by the one or more processors, a selection of a predefined graphical shape as selected from the predefined graphical shapes; generating, based on the selection of the predefined graphical shape by the one or more processors, a default graphical display depicting a default graphical curve having by a graphical curve type defined by each of: (a) the predefined graphical shape as selected, and (b) the data flow defined over the set time period, the default display configured for visualization on the GUI of the display screen of the client device; receiving, by the one or more processors, a selection of a unit time period selected from within the set time period, the unit time period displayed on the default graphical display; receiving, by the one or more processors, an override data value for overriding the expected data flow, the override data value defined for the unit time period as selected from within the set time period; generating, by the one or more processors, an overridden expected data flow defined over the set time period by updating the expected data flow with the override data value; dynamically updating, by the one or more processors, the default graphical curve to create an augmented graphical curve defined by the overridden expected data flow; and generating, based on the augmented graphical curve by the one or more processors, a dynamically updated graphical display depicting the augmented graphical curve having an updated portion visually depicting the overridden expected data flow over the set time period, the dynamically updated graphical display configured for visualization on the GUI of the display screen of the client device.

In some aspects, the techniques described herein relate to a cloud-based method further including: transmitting each of the selection display, the default display, and the dynamically updated graphical display to the client device over the computer network; and receiving each of the selection and the override data value from the client device over the computer network.

In some aspects, the techniques described herein relate to a cloud-based method further including: setting as statically defined the override data value within overridden expected data flow defined over the set time period.

In some aspects, the techniques described herein relate to a cloud-based method further including: generating, as part of a display, a graphical element indicating that the override data value is a statically defined value within the overridden expected data flow.

In some aspects, the techniques described herein relate to a cloud-based method further including: converting the overridden expected data flow of the augmented graphical curve into a data flow graph having a converted curve data format, storing the data flow graph into a database; loading the data flow graph from the database; and regenerating, based on the data flow graph from the database, the dynamically updated graphical display depicting the augmented graphical curve having the updated portion visually depicting the overridden expected data flow over the set time period, the dynamically updated graphical display configured for visualization on the GUI of the display screen of the client device.

In some aspects, the techniques described herein relate to a cloud-based method, wherein the converted curve data format includes a compressed data format stored in a single non-denormalized column of the database.

In some aspects, the techniques described herein relate to a cloud-based method, wherein one or more portions of the expected data flow are received in a plurality of different formats when analyzed by the one or more processors, and the cloud-based method further including: converting the one or more portions of the expected data flow to a normalized format.

In some aspects, the techniques described herein relate to a cloud-based method, wherein the normalized format includes a JavaScript Object Notation (JSON) format.

In some aspects, the techniques described herein relate to a cloud-based method further including: updating one or more remaining data values other than the override data value within the overridden expected data flow defined over the set time period, wherein the augmented graphical curve is created to graphically depict each of the override data value and the one or more remaining data values, each as updated in the overridden expected data flow as triggered by a change in the override data value.

In some aspects, the techniques described herein relate to a tangible, non-transitory computer-readable medium storing instructions for visualizing dynamically updated data flows, that when executed by one or more processors cause the one or more processors to: input, by one or more processors accessible over a computer network, an expected data flow defined over a set time period; generate, by the one or more processors, a selection display depicting each of a set of predefined graphical shapes, the selection display configured for visualization on a graphic user interface (GUI) of a display screen of a client device, each predefined graphic shape defining a graphical curve type of an expected data flow; receive, by the one or more processors, a selection of a predefined graphical shape as selected from the predefined graphical shapes; generate, based on the selection of the predefined graphical shape by the one or more processors, a default graphical display depicting a default graphical curve having by a graphical curve type defined by each of: (a) the predefined graphical shape as selected, and (b) the data flow defined over the set time period, the default display configured for visualization on the GUI of the display screen of the client device; receive, by the one or more processors, a selection of a unit time period selected from within the set time period, the unit time period displayed on the default graphical display; receive, by the one or more processors, an override data value for overriding the expected data flow, the override data value defined for the unit time period as selected from within the set time period; generate, by the one or more processors, an overridden expected data flow defined over the set time period by updating the expected data flow with the override data value; dynamically update, by the one or more processors, the default graphical curve to create an augmented graphical curve defined by the overridden expected data flow; and generate, based on the augmented graphical curve by the one or more processors, a dynamically updated graphical display depicting the augmented graphical curve having an updated portion visually depicting the overridden expected data flow over the set time period, the dynamically updated graphical display configured for visualization on the GUI of the display screen of the client device.

In accordance with the above, and with the disclosure herein, the techniques of the present disclosure improve the functioning of a computer by providing a GUI based method for updating data flows and triggering updates to all data segment(s) (e.g., unit time period) within a data group over a set time period, and implementing graphical visualizations of predefined graphical shapes that are updated, e.g., in real-time over a computer network from a cloud-based platform, based on the updated data flow. Accordingly, the techniques of the present disclosure improve the functioning of a computer, as compared to conventional techniques, at least because such conventional techniques lack the ability to implement such cloud-based data flow updates and visualization, and/or require manual manipulation in order to achieve curve or graphed based updates.

Additionally, the present disclosure includes improvements in computer functionality or in improvements to other technologies at least because the disclosure describes that, e.g., data flow, overridden expected data flow, and/or other data described herein may be formatted, normalized, and stored and then reloaded for display or redisplay via a GUI as described herein. For example, the one or more processors may save and load data (e.g., of a data flow and/or or augmented or overridden data flow) by converting such data flow related to the data flow, a JavaScript Object Notation (JSON) data format and saving in a database (e.g., a relational database and/or a NoSQL database). This allows for quickly saving, retrieving, and then regenerating for display graphical curves without excessive indexing or in-memory storage of the graphical curves in a database (e.g., a database stored in memory). This provides a compact form of storage allowing for storing multiple data flows without needing to save the related graphics, and thereby implement a reduced data storage footprint. This improves over the prior art at least because existing systems fail to allow storage of overridden expected data flow values, and, thus, do not recreate visualized graphics from data flows as augmented and stored in an efficient manner as described herein.

In addition, the present disclosure includes specific features other than what is well-understood, routine, conventional activity in the field, or adding unconventional steps that confine the claim to a particular useful application, e.g., cloud-based systems and methods for visualizing dynamically updated data flows.

Advantages will become more apparent to those of ordinary skill in the art from the following description of the preferred embodiments which have been shown and described by way of illustration. As will be realized, the present embodiments may be capable of other and different embodiments, and their details are capable of modification in various respects.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an example computing environment, including a cloud-based system for visualizing dynamically updated data flows, in accordance with various embodiments described herein.

FIG. 2 is a flowchart illustrating an example method for method for visualizing dynamically updated data flows, in accordance with various embodiments described herein.

FIG. 3 illustrates an example graphical user interface (GUI) depicting a set of predefined graphical shapes, in accordance with various embodiments described herein.

FIG. 4 illustrates an example GUI depicting a default graphical display having a default graphical curve, in accordance with various embodiments described herein.

FIG. 5A illustrates an example GUI depicting a unit time period that may be selected from within a set time period, in accordance with various embodiments described herein.

FIG. 5B illustrates an example GUI an override data value for overriding an expected data flow of the unit time period of FIG. 5A, in accordance with various embodiments described herein.

FIG. 5C illustrates an example GUI graphically indicating that the override data value of FIG. 5C is a statically defined value within the overridden expected data flow a set of predefined graphical shapes, in accordance with various embodiments described herein.

FIG. 6 illustrates an example GUI depicting a dynamically updated graphical display depicting the augmented graphical curve having an updated portion visually depicting the overridden expected data flow over the set time period, in accordance with various embodiments described herein.

The Figures depict preferred embodiments for purposes of illustration only. Alternative embodiments of the systems and methods illustrated herein may be employed without departing from the principles of the invention described herein. Accordingly, the drawings and description are to be regarded as illustrative in nature and not as restrictive and/or limiting.

### DETAILED DESCRIPTION OF THE INVENTION

Generally speaking, the techniques of the present disclosure provide cloud-based and graphical user interface (GUI) technical solution to adapt data flows, which may be in real-time given that some data flows may constantly change and need to be adapted. In this manner, the techniques of the present disclosure improve over conventional techniques by providing a graphical and cloud-based stool for selecting predefined graphical shapes, overriding values, and generated augmented shapes on a GUI for graphical visualization in a manner that was previously not implemented with such conventional techniques.

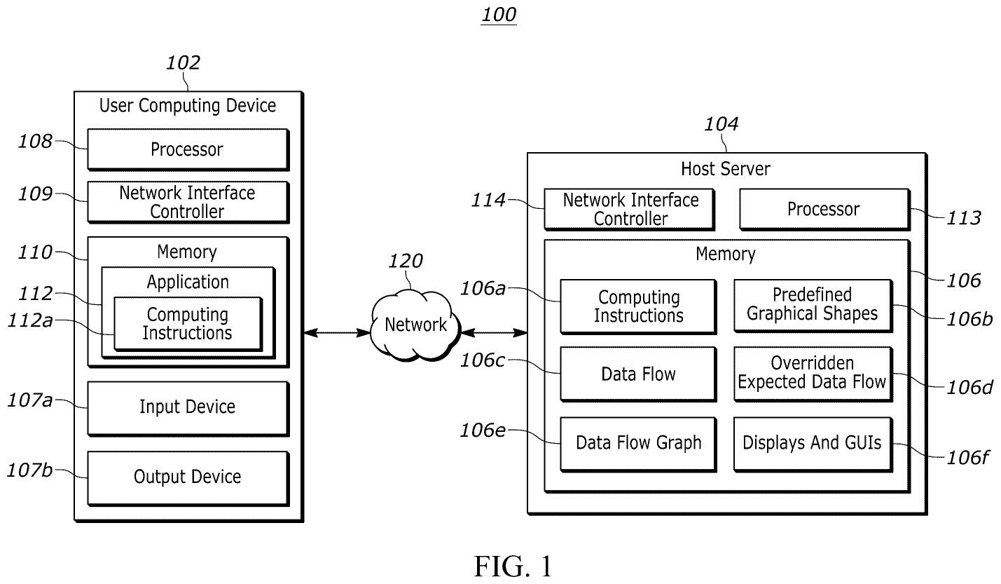

FIG. 1 illustrates an example computing environment 100, including a cloud-based system for visualizing dynamically updated data flows, in accordance with various embodiments described herein. The computing environment 100 includes a user computing device 102, a host server 104, and a network 120. Some embodiments may include a plurality of user computing devices 102, and/or a plurality of host servers 104.

The user computing device 102 may include a processor 108, a network interface controller 109, and a memory 110. The memory 110 stores an application (app) 112. App 112 may comprise a set of computing instructions 112a stored on a computer memory and executable by a processor for implementing the methods or otherwise algorithms for visualizing dynamically updated data flows as described herein.

The user computing device 102 may also include an input device 107a, and an output device 107b. The input device 107a may include any suitable device or devices for receiving input, such as one or more microphone, one or more camera, a hardware keyboard, a hardware mouse, a capacitive touch screen, etc. The output device 107b may include any suitable device for conveying output, such as a hardware speaker, a computer monitor, a touch screen, or the like. In some cases, the input device 107a and the output device 107b may be integrated into a single device, such as a touch screen device that accepts user input and displays output. The user computing device 102 may communicate with the host server 104 across the network 120 (e.g., a computer network such as the Internet) via the network interface controller 109.

Generally, the host server 104 may include a memory 106, a processor 113, and a network interface controller 114. The memory 106 may store a computing instructions 106a, a predefined graphical shapes 106b, a data flow 106c, an overridden expected data flow 106d, a data flow graph 106e, and/or a displays and GUIs 106f. Broadly, the host server 104 may execute computing instructions 106a for performing any of the methods, algorithms, or otherwise features described herein. Still further, computing instructions 106a may be implemented or executed to access each of the predefined graphical shapes 106b, values of the data flow 106c, values of the overridden expected data flow 106d, the data flow graph 106e, and/or a displays and GUIs 106f.

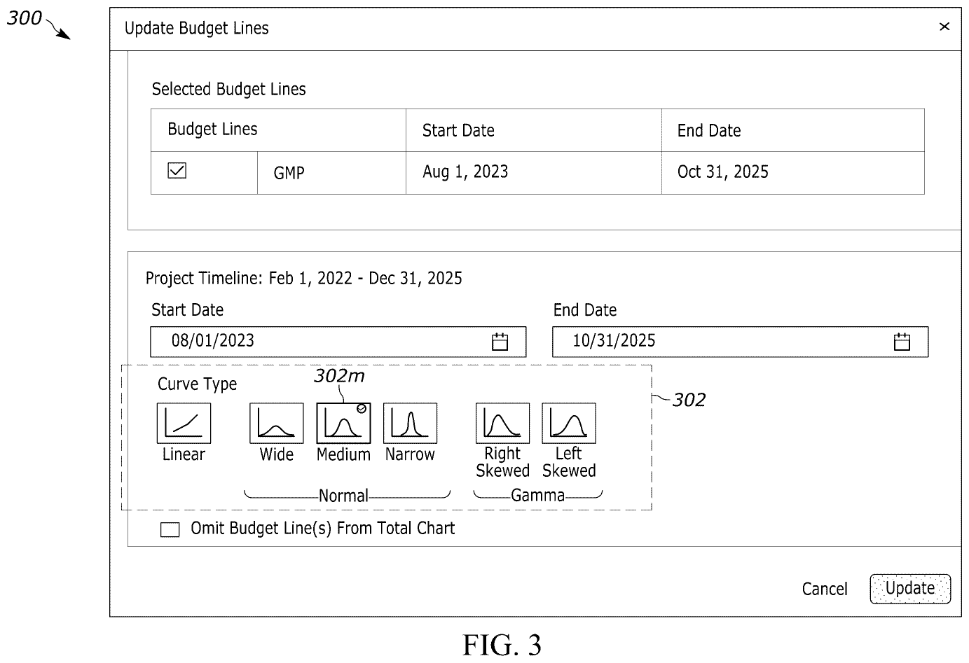

Displays and GUIs 106f may comprise graphical screen rendering or templates, for example as defined in hypertext markup language (HTML), JavaScript (JS), Cascading Style Sheets (CSS) or similar computing code for rendering GUIs or displays on a screen of a computing device (e.g., user computing device 102). Predefined graphical shapes 106b may comprise images (e.g., rasterized and/or vector-based images), such as those described herein for any one or more of FIGS. 3-6 for rendering on a display or graphic user interface (GUI) (e.g., the displays and/or GUIs of any one or more of FIGS. 3-6).

Memory 106 may store data used or accessed for rendering or partially rendering displays or GUIs (e.g., the displays and/or GUIs of any one or more of FIGS. 3-6). Such data may include values of one or more data flows (e.g., data flow 106c), values of one or more overridden expected data flows (e.g., overridden expected data flows), and/or values or graphics related to one or more data flows graphs (e.g., data flow graph 106e). Some or all of such information may be saved in memory 106 and loaded at a later time in order to create or recreate any of the displays and/or graphic user interface (GUI) (e.g., the displays and/or GUIs of any one or more of FIGS. 3-6).

Generally speaking, each of the user computing device 102 and/or the host server 104 may be individual computing devices, a group of multiple computing devices, an individual server, a group (e.g., cluster) of multiple servers, and/or another suitable type of computing device or system (e.g., a collection of computing resources). In some aspects, one or more components of the user computing device 102 and/or the host server 104 may be embodied by one or more virtual instances (e.g., a cloud-based virtualization service). In such cases, the one or more user computing devices 102 and/or the one or more host servers 104 may be included in a remote data center (e.g., a cloud computing environment, a public cloud, a private cloud, etc.).

However, regardless of the specific implementation of the user computing device 102 and/or the host server 104, a user may utilize the user computing device 102 to access the host server 104 in order to access displays, GUIs, graphics, data, values, and/or or information or assets described herein as stored therein (e.g., any one or more of 106b-106f). That is the or more memories 106,110 may be communicatively coupled with the one or more processors 108, 113. In this manner, the user computing device 102 may retrieve and/or otherwise access the data or other information for visualizing dynamically updated data flows.

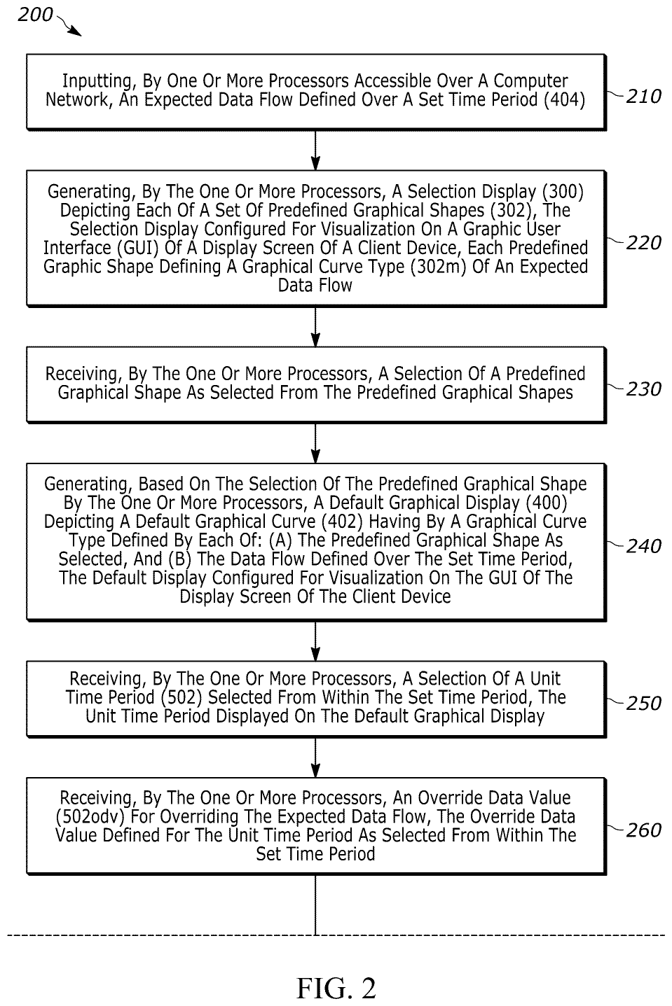

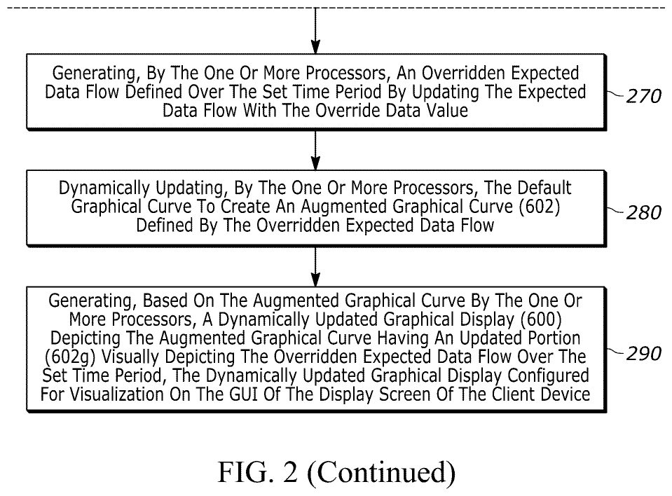

In any event, as previously mentioned, the user computing device 102 and the host server 104 include processors 108, 113 and network interface controllers 109, 114, respectively. The processors 108, 113 may include any suitable number of processors and/or processor types, such as CPUs and one or more graphics processing units (GPUs). Generally, the processors 108, 113 are configured to execute software instructions stored in the memories 110, 106, such as the app 112 comprising computing instructions 112a, computing instructions 106a, and/or otherwise instructions for implementing the methods and algorithms disclosed herein. In some aspects, computing instructions 112a may be executed by processor 108 to implement the methods and algorithms as described herein (e.g., the method of FIG. 2) alone without communication to host server 104. Alternatively, computing instructions 112a may be executed by processor 108 to send and receive data, graphics, GUIs, displays, and other information, e.g., stored in memory 106, to and from host server 104 implement the methods and algorithms as described herein (e.g., the method of FIG. 2). In such aspects, host server 104 may, in response to receiving a request from user computing device 102, may execute computing instructions 106a to access and return the data, graphics, GUIs, displays, and other information, e.g., stored in memory 106, to user computing device 102, e.g., for analysis, execution, and for display output device 107b, e.g., a display screen.

Further, the processors 108, 113 may be connected to the memories 110, 106, respectively, via a computer bus responsible for transmitting electronic data, data packets, or otherwise electronic signals to and from the processors 108, 113 and the memories 110, 106 in order to implement or perform the machine readable instructions, methods, processes, elements or limitations, as illustrated, depicted, or described for the various flowcharts, illustrations, diagrams, figures, and/or other disclosure herein.

The processors 108, 113 may interface with the memories 110, 106, respectively, via the computer bus to execute an operating system (OS). The processors 108, 113 may also interface with the memories 110, 106 via the computer bus to create, read, update, delete, or otherwise access or interact with the data stored in the memories 110, 106. The data stored in memories 110, 106 may include all or part of any of the data or information described herein, and/or any other data stored in the memories 110, 106.

The memories 110, 106, respectively, may include one or more persistent memories (e.g., a hard drive/solid state memory) and may store one or more set of computer executable instructions/modules. In general, a computer program or computer based product, application, or code (e.g., the computing instructions 106a and other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processors 108, 113 (e.g., working in connection with the data in the memories 110, 106), respectively, to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The memories 110, 106 may include, respectively, one or more forms of non-transitory, volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In certain aspects, the memories 110, 106 may store an operating system (OS) (e.g., Microsoft Windows, Linux, Unix, etc.) capable of facilitating the functionalities, applications, methods, or other software as discussed herein.

The memories 110, 106 may also store any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, or otherwise be part of the various applications/modules/models described herein, where each may be configured to facilitate their various functionalities discussed herein. It should be appreciated that one or more other applications may be envisioned and that are executed by the processors 108, 113, respectively.

The network interface controllers 109, 114 may include any suitable network interface controller(s), respectively, such as wired/wireless controllers (e.g., Ethernet controllers), and facilitate bidirectional/multiplexed networking over the network 120 between the user computing device 102 and other components of the environment 100 (e.g., host server 104). The network 120 may be a single communication network or may include multiple communication networks of one or more types (e.g., one or more wired and/or wireless local area networks (LANs), and/or one or more wired and/or wireless wide area networks (WANs) such as the Internet). The network 120 may enable bidirectional communication between the host server 104 and the user computing device 102, and/or between multiple user computing devices 102, for example. According to some embodiments, the user computing device 102 and/or the host server 104 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to a computer network.

In some embodiments, the user computing device 102 and/or the host server 104 may include a client-server platform technology such as ASP.NET, Java J2EE, Ruby on Rails, Node.js, a web service or online API, responsive for receiving and responding to electronic requests. The user computing device 102 and/or the host server 104 may implement the client-server platform technology that may interact, via the computer bus, with the memories 110, 106 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

The user computing device 102 and/or the host server 104 may further include or implement an operator interface configured to present information to an administrator or operator and/or receive inputs from the administrator or operator. For example, an operator interface may provide a display screen (e.g., via input device 107a or output device 107b). The user computing device 102 and/or the host server 104 may also provide I/O components (e.g., ports, capacitive or resistive touch sensitive input panels, keys, buttons, lights, LEDs), which may be directly accessible via or attached to the user computing device 102 and/or the host server 104 or may be indirectly accessible via or attached to an internal user computing device. According to some embodiments, an administrator or operator may access the host server 104 by the user computing device 102 to review information (e.g., display or GUIs, or graphics and/or data presented thereon), make changes, input data categories, and/or perform other functions.

As described above herein, in some embodiments, the user computing device 102 and/or the host server 104 may perform the functionalities as discussed herein as part of a “cloud” network or may otherwise communicate with other hardware or software components within the cloud to send, retrieve, or otherwise analyze data or information described herein.

FIG. 2 is a flowchart illustrating an example method 200 for method for visualizing dynamically updated data flows, in accordance with various embodiments described herein. Method 200 may be implemented via computing environment 100, including a cloud-based system, where method 200 may be executed by processors 108 and/or 113 accessing memory 110, 106 (and data or other information stored therein), respectively, of user computing device 102 and/or 106. FIG. 2 is described and illustrated, in part, by the displays and GUIs of FIGS. 3-6, herein. It is to be understood, however, that different and/or additional displays and GUIs may be utilized.

Further, the data flows of the examples of FIGS. 3-6 represent a cash flow scenario, where in the example of FIGS. 3-6 the data flow, data flow graphs, display, and GUIs are represented as a cash flow embodiment specific to a real estate development project. However, it is to be understood, that a data flow may be related to any flow of data, e.g., across a given time period or unit time periods, which may be graphically visualized as described herein.

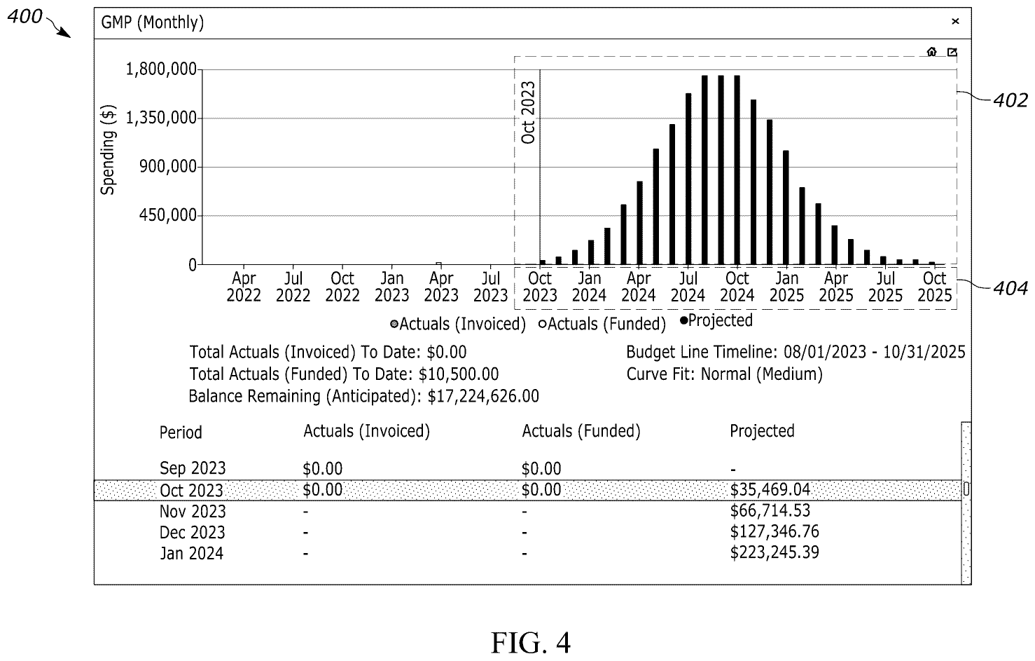

At block 210, method 200 comprises inputting, by one or more processors (e.g., processor 108 and/or 113) accessible over a computer network (e.g., network 120), an expected data flow defined over a set time period. The set time period may be for example, a series of months, for example, the set time period 404 as shown and described for FIG. 4, which includes monthly time periods (e.g., where each month is a unit time period) over a set time period from August 2023 to October 2025.

In some aspects, the data to be used for the data flow can be received in different formats and can be formatted into a common format. For example, in some aspects, one or more portions of the expected data flow can be received in a plurality of different formats when analyzed by the one or more processors. In such aspects, the one or more portions of the expected data flow may be converted to a normalized format. In some aspects, the normalized format may comprise a JavaScript Object Notation (JSON) format.

At block 220, method 200 comprises generating, by the one or more processors, a selection display 300 depicting each of a set of predefined graphical shapes 302. For example, FIG. 3 illustrates an example graphical user interface (GUI) depicting a set of predefined graphical shapes 302, in accordance with various embodiments described herein. As shown for FIG. 3, the predefined graphical shapes 302 may comprise graphical shapes defining or otherwise correlated with specific types of data flow types and/or distributions. That is, each predefined graphic shape may define a graphical curve type 302m of an expected data flow. The graphical curve types may comprise curve fit graphics mapping to one or more data distributions, e.g., linear distributions, normal distributions (wide, medium, narrow), and skewed type distributions. In various aspects, selection display 300 is configured for visualization on a graphic user interface (GUI) of a display screen of a client device (e.g., a computer screen or mobile device screen such as output device 107b).

At block 230, method 200 comprises receiving, by the one or more processors, a selection of a predefined graphical shape as selected from the predefined graphical shapes. That is a user may select a predefined graphical shapes 302 from selection display 300. The user may also provide as input a set time period (e.g., from August 2023 to October 2025), also referred to in the embodiment of FIG. 3 as a project timeline. The user may select to assign or otherwise update the data flow with the given curve type (e.g., a graphical curve type 302m). For example, a user may select a curve fit for an expected data flow (e.g., a data flow tied to an expected cash flow or budget line). A user may select a best curve fit for the given data flow of a given project or otherwise project budget.

At block 240, method 200 comprises generating, based on the selection of the predefined graphical shape by the one or more processors, a default graphical display. FIG. 4 illustrates an example GUI depicting a default graphical display 400 having a default graphical curve 402, in accordance with various embodiments described herein. In the example of FIG. 4, default graphical curve 402 has a default distribution or otherwise default data type relation to a normal distribution of data. In particular, as shown for the example of FIG. 4, default graphical display 400 depicts default graphical curve 402 having by a graphical curve type defined by each of: (a) the predefined graphical shape as selected (e.g., a medium normal distribution as may have been selected as shown for FIG. 3), and (b) the data flow defined over the set time period (e.g., from August 2023 to October 2025). The default graphical display configured for visualization on the GUI of the display screen of the client device (e.g., the computer screen or mobile device screen such as output device 107b).

In the example of FIG. 4, the selection of the predefined graphical shape as selected (e.g., a medium normal distribution as may have been selected as shown for FIG. 3), caused the processors to generate the default graphical display 400 having a graphic (e.g., the predefined shape) and related data spread out across the data flow defined over the set time period (e.g., from August 2023 to October 2025) by using the selected curve fit for the given predefined graphical shape. In this way, as demonstrated for FIG. 4, distributions can spread over a default continuous time interval, but where the data flow is defined across discrete time periods or otherwise unit time periods across a set time period (e.g., monthly based time periods as shown for FIG. 4). In the example of FIG. 4, the data flow relates to a real-estate development project and data flows (e.g., cash flows) related thereto. As shown, the real-estate project is divided into a discrete number of data chunks (referred to as requisition periods), which are represented by each of the time periods or unit time periods. The data curve is broken up into number of units that match a user's requisition periods and the start/end date for their data flows (e.g., cash flows) lines. The user can then fit an expected budget to the curve, which allows a user to predict expenses for each month or otherwise time period or unit time period.

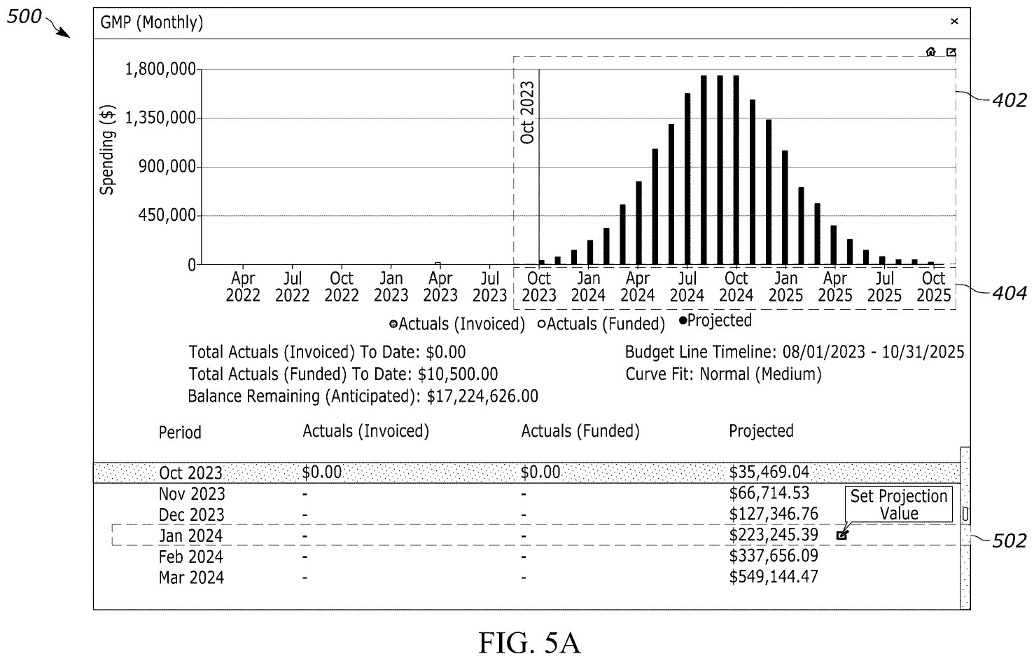

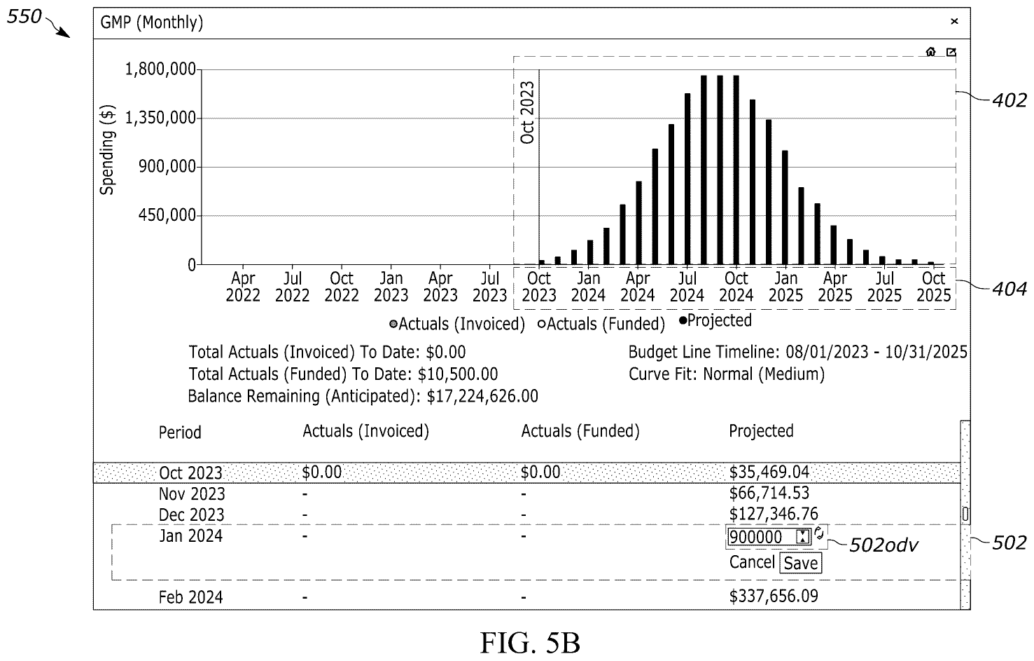

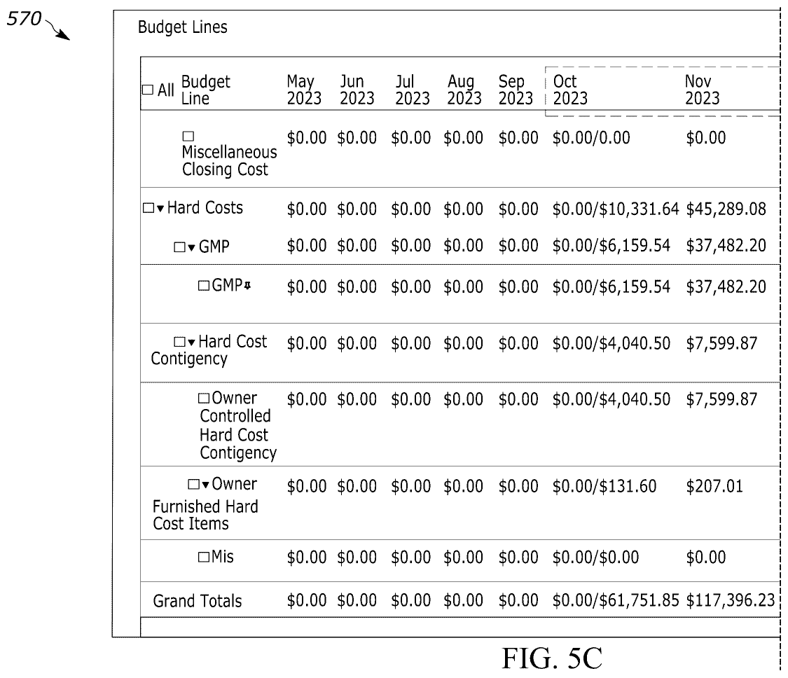

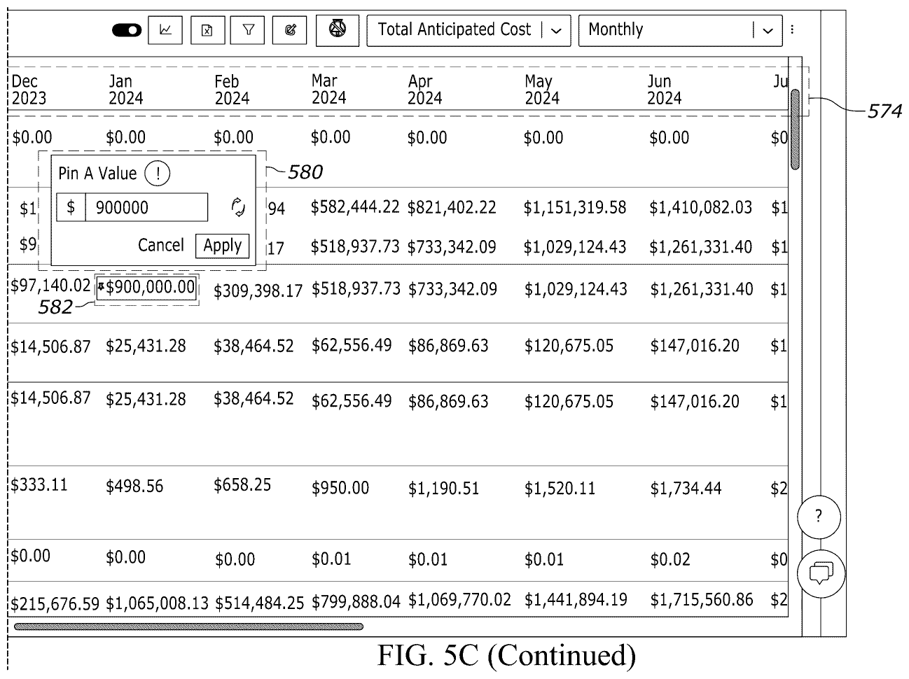

At block 250, method 200 comprises receiving, by the one or more processors, a selection of a unit time period selected from within the set time period. The unit time period displayed on the default graphical display 400. For example, FIG. 5A illustrates an example GUI depicting a unit time period 502 (e.g., a month such as January 2024) that may be selected from within a set time period, in accordance with various embodiments described herein. For example, the user may select to edit the unit time period 502 from default graphical display 400.

At block 260, method 200 comprises receiving, by the one or more processors, an override data value for overriding the expected data flow. The override data value defined for the unit time period as selected from within the set time period. For example, FIG. 5B illustrates an example GUI an override data value 502odv for overriding an expected data flow of the unit time period 502 of FIG. 5A, in accordance with various embodiments described herein. As shown for FIG. 5B, the selection of the time period 502 caused an input to appear allowing the user to input override data value 502odv, which overrides the value as originally generated for the data flow for the specific unit time period 502. The user may save the override data value 502odv, which will cause the default graphical curve 402 to be graphically updated.

FIG. 5C illustrates an example GUI graphically indicating that the override data value 502odv of FIG. 5C is a statically defined value within the overridden expected data flow a set of predefined graphical shapes 302, in accordance with various embodiments described herein. For example, as shown for FIG. 5C, a user is able to set as statically defined an override data value (e.g., pin value 580) within overridden expected data flow value (e.g., $900,000) defined over or for a set time period.

In some aspects, the statically defined value may be indicated or otherwise defined a graphical pin a value. A graphical element a graphical element 582 (e.g., a pin graphic) may be generated, as part of a display, where the graphical element 582 indicates that the override data value 580 is a statically defined value within the overridden expected data flow. For example, a user may use the override data value 580 to adjust a given curve (e.g., predefined graphical shape) while retaining at least a portion of the overall shape or pattern. For example, the customer can provide override data value 580, which can then be apportioned and/or subtracted from each of the remaining periods on the curve thereby retaining the curve shape, but at the same time adjusting projected data values in the other periods to account for the known override data value 580. In this way, a user can manipulate curves by pinning values that they know will occur, and the remaining curve values will be automatically, by the one or more processors, adjusted to the correct total in the context of the remaining values across the set time period.

At block 270, method 200 comprises generating, by the one or more processors, an overridden expected data flow defined over the set time period by updating the expected data flow with the override data value. Thus, a user can manipulate a data flow and related graphical curve by pinning or otherwise setting values that they know will occur, and where the processors will automatically adjust the remaining curve values to account for a total amount (total data flow) over the set time period. This allows a user to adjust the display or otherwise GUI in real-time and/or otherwise for constantly adapting data flow projections. That is, the GUI provides the ability for a user to override a projection amount for a given period (e.g., pinning a value for a given data flow that differs from the default curve with ability for the curve to auto-fit around the pinned or otherwise augmented value, e.g., as further described herein).

At block 280, method 200 comprises dynamically updating, by the one or more processors, the default graphical curve to create an augmented graphical curve defined by the overridden expected data flow. In one example aspect, this can be implemented by the one or more processors by updating one or more remaining data values other than the override data value within the overridden expected data flow defined over the set time period. That is, the user's manual adjustment via the override data value 580 will adjust the curve while retaining the overall shape. To implement this, the override data value 580 is subtracted or added (as the case may be) to the overall amount or total value, and the remaining values are adjusted over the set period of time while still maintaining the overall shape or otherwise data distribution (e.g., normal distribution) as originally defined by the predefined graphic shape. In this way, the augmented graphical curve is created to graphically depict each of the override data value and the one or more remaining data values, each as updated in the overridden expected data flow as triggered by a change in the override data value.

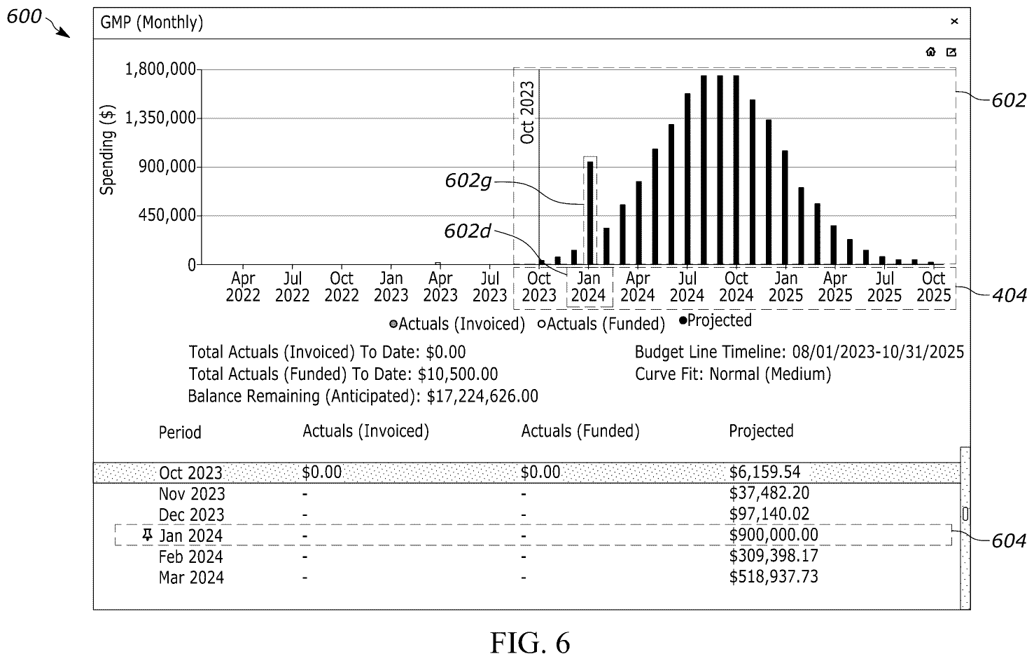

At block 290, method 200 comprises generating, based on the augmented graphical curve by the one or more processors, a dynamically updated graphical display depicting the augmented graphical curve having an updated portion visually depicting the overridden expected data flow over the set time period. For example, FIG. 6 illustrates an example GUI depicting a dynamically updated graphical display 600 depicting the augmented graphical curve 602 having an updated portion 602g visually depicting the overridden expected data flow over the set time period (e.g., set time period 404), in accordance with various embodiments described herein. As shown in the example of FIG. 6, the dynamically updated graphical 600 display is configured for visualization on the GUI of the display screen of the client device (e.g., output device 107b).

In one example, after the host server 104 receives each of the selection and the override data value (e.g., override data value 502odv) from the client device (e.g., user computing device 112) over the computer network, the updated data flow and/or graphical curves may be transmitted to the client device (e.g., user computing device 112), where each of a selection display, default display, and a dynamically updated graphical display may be sent to over the computer network or otherwise rendered on the client device based on the updated data (e.g., overridden expected data flow) and related updated graphics and curve and data.

In various aspects the data flow, overridden expected data flow, and/or other data described herein may be formatted, normalized, and stored and then reloaded for display or redisplay via a GUI as described herein. For example, the one or more processors may save and load data (e.g., of a data flow) by converting such data flow related to the data flow, a JavaScript Object Notation (JSON) data format and saving in a database (e.g., a relational database and/or a NoSQL database). This allows for quickly saving, retrieving, and then regenerating for display graphical curves without excessive indexing or in-memory storage of the graphical curves in a database (e.g., a database stored in memory). This provides a compact form of storage allowing for storing multiple data flows without needing to save the related graphics, and thereby implement a reduced data storage footprint.

Additionally, or alternatively, one or more processors (e.g., processor 108 and/or 113) may convert the overridden expected data flow of the augmented graphical curve into a data flow graph having a converted curve data format. For example, in one aspect, the covered curve data format may comprise the JavaScript Object Notation (JSON) data format. The data flow graph may then be stored into a database (e.g., in a memory, such as memory 106).

Additionally, or alternatively, the converted curve data format may comprise a compressed data format stored in a single non-denormalized column of the database. In such aspects, by storing the data in a single non-denormalized column, rather than denormalized into different database columns, reduces storage requirements for the data flow data and/or converted curve data.

The data flow graph may be loaded from the database, and, in some aspects regenerated based on the data flow graph from the database. The dynamically updated graphical display 600 may then be updated to depict the augmented graphical curve having the updated portion visually depicting the overridden expected data flow over the set time period, where the dynamically updated graphical display configured for visualization on the GUI of the display screen of the client device (e.g., output device 107b). Such functionality allows for the system to quickly save and retrieve data without excessive indexing or in-memory storage in our database. This provides and efficient and compact form of storage of data allowing the one or more processors to save a data flows in a reduced memory footprint, and then retrieve and reproduce a graphic for display therefrom without having to store the related graphics, which allows for reduced and efficient storage and retrieval of data flows (e.g., the overridden expected data flow) as described herein.

### Additional Embodiments

In various embodiments, the one or more processors accessible over computer network are configured to facilitate seamless communication and data exchange between various components of the system. In an embodiment, these processors may be implemented as cloud-based servers utilizing distributed computing architecture, allowing for scalability and flexibility in handling multiple user requests simultaneously. Each processor is equipped with algorithms that enable real-time processing and analysis of complex mathematical functions defining expected flow curves.

In another embodiment, the processors are integrated into client-side devices such as laptops or mobile phones, enabling users to access the system remotely through a secure connection. The processors may also be configured in a hybrid architecture, combining cloud-based servers with local device storage for improved performance and data security. Furthermore, the processors may employ compression algorithms like JPEG2KO to optimize image transmission over networks while maintaining visual fidelity.

In yet another embodiment, multiple processing units are utilized within each processor node, allowing parallel computing capabilities that accelerate complex calculations involved in generating graphical representations of expected flow curves. Additionally, these nodes may be configured with dedicated memory modules for storing predefined shapes and user-defined templates, enabling efficient retrieval and rendering of graphics on demand. By leveraging technologies such as GPU acceleration and multi-threading, the processors are capable of handling high-volume data processing tasks while maintaining responsive performance.

The one or more memories communicatively coupled with one or more processors store predefined graphical shapes that define various types of expected data flow curves. In a first embodiment, these graphs are stored as vector graphics in memory and may be retrieved by the processor for rendering on a graphic user interface (GUI) screen. The vectors may comprise mathematical equations defining linear, non-linear, step functions, or other custom-defined curve patterns.

In another embodiment, the predefined graphical shapes are raster images that have been compressed using algorithms such as JPEG2000 to reduce their size while maintaining visual fidelity. These raster graphics may be stored in memory and retrieved by the processor for display on a GUI screen without requiring additional processing steps.

Furthermore, some embodiments may employ data compression techniques like progressive rendering or delta encoding to optimize transmission of graphical updates over computer networks between client devices. This enables efficient transfer of updated curves while minimizing network bandwidth usage.

In yet another embodiment, predefined shapes may be stored as mathematical functions that define the expected flow curve patterns. These equations are executed by the processor upon user selection and generate a default graph for visualization on the GUI screen. The system may also allow users to create custom templates or libraries from these graphical representations across multiple projects, enabling reusability of design elements.

In addition, some embodiments provide support for storing augmented graphs in memory using compression algorithms that optimize storage space while maintaining data integrity. This enables efficient handling and retrieval of large datasets without compromising performance.

In one embodiment, these instructions utilize vector graphics libraries such as SVG or ADOBE ILLUSTRATORS.AI format to store pre-defined curves representing different types of flow patterns, including linear and non-linear trends, step functions, exponential growth models, sinusoidal waves, and custom-designed templates for specific applications. Upon user input selecting a predefined shape from the library, these instructions map this selection onto corresponding mathematical algorithms or formulas that define those shapes, generating default graphical representations on the GUI screen.

In yet another embodiment, the system utilizes machine learning-based analytics tools to provide insights into trends and patterns present throughout expected flow curves by analyzing statistical distributions (e.g., mean, median), visualizing outliers or anomalies, detecting trend changes using regression analysis algorithms, and customizable dashboards for monitoring specific metrics over time.

This process begins by selecting from various predefined shapes, such as linear curves or non-linear functions like sine waves, which are stored in memory as vector graphics or raster images depending on the system's architecture. Users may choose these shapes based on specific data flows they wish to visualize, ensuring that their input accurately reflects real-world scenarios.

In an embodiment, upon selecting a predefined shape, the default graph is generated by mapping this selection to corresponding mathematical functions or algorithms that define those shapes. This ensures seamless integration of graphical representations with real-world data flows. Users may also input expected flow using methods beyond defining over set time periods, including historical analysis and user-defined formulas for generating curves.

In addition, users may specify the unit time period within a displayed curve by selecting contiguous intervals to ensure accurate representation of their anticipated patterns. This flexibility allows users to tailor their visualizations according to specific needs or organizational structures. Furthermore, override data values entered using various formats such as numerical input, text-based inputs like “50% increase,” date and time ranges, Boolean flags, or toggle switches are handled by the system's parsing algorithms for seamless integration.

When multiple users attempt to update overridden expected flows simultaneously over the same period, a conflict resolution mechanism may be implemented. For instance, in one embodiment, user with highest privilege level takes precedence; while another approach involves timestamp-based overwrite of older updates. This ensures that data integrity is maintained and accurate representation remains consistent across all visualizations.

The system may employ various techniques such as caching and lazy loading to optimize performance by only rendering those shapes that are currently visible within a specific viewport area of the display window.

In another embodiment, when generating this selection screen, the system may utilize graphics processing units (GPUs) or dedicated hardware accelerators for accelerated vector graphics manipulation. This enables fast and efficient transformation of predefined graphical shapes into various formats suitable for visualization on GUI screens with diverse resolutions and aspect ratios.

Furthermore, to enhance user experience during shape selection, an embodiment may incorporate interactive features such as hover effects, tooltips, and zooming capabilities allowing users to dynamically explore the available options without having to navigate through a lengthy list or menu. Additionally, this display may be designed in accordance with accessibility guidelines for visually impaired individuals by incorporating assistive technologies like screen readers, high contrast modes, and font size adjustment.

In yet another embodiment, when generating an augmented graphical curve based on user selection of predefined shapes, the system may employ algorithms such as Bezier curves or B-spline interpolation to create smooth transitions between adjacent segments. This ensures a visually appealing representation that accurately reflects changes made by users during data flow modification processes.

To facilitate customization and personalization, another embodiment allows users to save their preferred graphical shape selection for future use in the form of reusable templates or libraries accessible across multiple projects. These pre-defined shapes may be stored locally on client devices or remotely within a centralized repository, enabling seamless sharing among team members with varying levels of clearance access.

This selection process involves mapping user input to corresponding mathematical functions or algorithms defining those shapes in memory. For instance, when choosing a linear curve shape, the system may employ a simple arithmetic progression formula (e.g., y=mx+b) where m and b are constants representing slope and intercept respectively; whereas selecting an exponential growth model might involve applying a function like f(x)=ab\hat{ }x with parameters ‘a’ for initial value and ‘b’ for rate of change (e.g., for a linear distribution). In another embodiment, users may input expected data flows using historical analysis or statistical modeling techniques to generate curves that reflect past trends.

This process begins with users selecting predefined graphical shapes from memory-stored templates, which may include linear curves, non-linear curves such as sine waves, step functions, exponential growth models, sinusoidal patterns, and custom-defined shapes for specific data flows. Once a shape is chosen, the system prompts users to input expected data flow values over a set time period or using alternative methods like historical analysis of past trends, statistical modeling based on historical patterns, user-defined formulas generating curves (e.g., polynomial equations), date ranges, boolean flags, and toggle switches.

In one embodiment, when selecting shapes from memory-stored templates, users may opt for linear interpolation between predefined points to create a smooth curve. In another embodiment, the system allows users to input expected data flow values using various formats such as text-based inputs (e.g., “50% increase”), date ranges, and Boolean flags or toggle switches; these alternative formats are converted into numeric values by parsing algorithms.

Upon selecting shapes and entering expected data flows, the default graphical curve is generated based on mathematical functions defining those selected shapes. For instance, if a user chooses a linear shape with an exponential growth model as its underlying function, the system will generate a corresponding graph that reflects this relationship between time periods and numerical values. In another embodiment, users may input override data flow curves for specific parts of expected flows; these overrides are then integrated into the overall graphical representation.

To optimize visualization on GUI screens, default graphs may be compressed using algorithms like JPEG2000 to reduce image size without compromising quality or employ techniques such as progressive rendering and delta encoding. Additionally, custom templates may be created by saving predefined shapes within a centralized repository accessible across multiple projects; this feature enables users to build upon existing designs reducing the need for manual creation from scratch each time they encounter similar data flows in different contexts.

In another embodiment, users may create custom dashboards for visualizing expected flows and group related graphs together to focus attention on useful areas of interest while filtering out less relevant information. The system also includes built-in analytics tools providing insights into trends and patterns present throughout curves; these features include statistical analysis (e.g., mean, median), visualization of outliers or anomalies, trend detection using machine learning algorithms, and customizable dashboards for monitoring specific metrics over time.

When overriding expected data flows simultaneously by multiple users on the same computer network, a conflict resolution mechanism may be implemented where newer updates overwrite older ones based on timestamp-based approaches. Finally, to prevent unauthorized access and tampering with overridden data values once entered into the system, robust security measures such as encryption during transmission (HTTPS) and storage are employed along with secure authentication mechanisms for user login and session management.

This feature enables granular control over data analysis and visualization by allowing users to zoom-in on specific segments of interest within an otherwise complex flow pattern.

In one embodiment, this selection is achieved through interactive tools such as sliders, dropdown menus, or checkboxes integrated into the GUI interface. For instance, a user may select “monthly” or “quarterly” from a listbox menu option to isolate quarterly data points for setting a unit of period of time or as otherwise describe therein. In another embodiment, users may utilize keyboard shortcuts or hotkeys to quickly navigate between different time periods.

In yet another embodiment, this feature is implemented through visualization techniques such as zooming-in on specific regions of the graph using mouse gestures or touch-based interactions with a touchscreen device. For example, by pinching and spreading fingers across the screen, users may dynamically adjust their view from high-level overview to detailed analysis within seconds.

In some embodiments, multiple unit time periods may be selected simultaneously for comparison purposes, allowing users to analyze how different segments of an expected flow curve interact or influence one another over varying timescales. This feature is particularly useful in identifying correlations between distinct patterns and trends across diverse data sets.

Furthermore, this capability may also facilitate the creation of custom dashboards tailored to specific business needs by enabling users to define their own time-based filters for filtering out irrelevant information.

In addition, some embodiments may incorporate analytics capabilities within these unit-time period selection tools. For instance, statistical analysis or machine learning algorithms may be applied to identify patterns and trends emerging from selected data segments.

Moreover, this feature may also integrate with other system components such as alert systems by allowing users to set custom notifications based on specific conditions triggered when a particular time-based threshold is reached.

In one embodiment, when multiple users attempt to update overlapping segments within this predefined timeframe, the system employs conflict resolution mechanisms based on user role hierarchy or timestamp-based prioritization schemes. For instance, administrators may take precedence over regular users in case of conflicting updates.

Upon receiving an override request from a client device via computer network transmission protocols such as HTTPS and TCP/IP, the server-side processing unit extracts relevant information including time period boundaries, overridden value(s), and any applicable formatting requirements (e.g., date range validation). In another embodiment, external APIs or automated systems may also provide input values that are integrated into this process. The system then performs real-time data consistency checks against predefined rules stored in a database to ensure the validity of entered overrides.

In cases where multiple override requests conflict with each other within overlapping time periods (e.g., different users attempting to modify adjacent segments), the system can resolve these conflicts by prioritizing changes based on factors such as user role, timestamp of modification, or specific business logic defined for that particular data flow. This ensures accurate representation and minimizes potential inconsistencies.

Upon successful validation, the overridden expected data flow is updated accordingly within a database storage mechanism utilizing incremental updates with versioning control to maintain historical records and facilitate future revisions if needed. In another embodiment, users may opt to fill gaps in historical data by interpolating between available points or using default values for missing segments of an augmented graphical curve.

Upon receiving override requests from multiple clients simultaneously over the same time period, a distributed processing architecture enables parallel updates without compromising system performance through load balancing and caching mechanisms.

Furthermore, compression algorithms such as JPEG2000 may be employed to reduce transmission size while maintaining visual fidelity during data transfer between client devices.

In one embodiment, users may also set up custom notification triggers based on overridden flow curves by defining specific event-driven conditions within the platform's architecture (e.g., exceeding 90% capacity or detecting anomalies). Upon meeting these criteria, automated alerts may be sent to designated recipients for timely intervention.

This may be achieved through various input methods such as numerical inputs, text-based entries (e.g., “50% increase”), or date and time ranges. The entered overrides are then validated in real-time against predefined rules and constraints stored in a database, ensuring data consistency across multiple fields and preventing invalid values from being accepted.

In another embodiment, the system employs algorithms to interpolate between available data points when loading graphs from a database, filling gaps in historical records with default or estimated values as needed. This ensures that visualizations remain accurate and informative even for incomplete datasets. Furthermore, users may opt to fill these gaps manually by entering custom override values.

In yet another embodiment, the system utilizes machine learning algorithms to detect anomalies within expected flow curves based on statistical analysis of past trends and patterns. When an anomaly is detected, a notification triggers relevant stakeholders or administrators to investigate potential issues with data integrity or accuracy.

To resolve conflicts that may arise when multiple users attempt to update overridden expected flows simultaneously over the same time period, one embodiment prioritizes changes according to user role-based permissions (e.g., administrator takes precedence), while another approach uses timestamp-based conflict resolution where newer updates overwrite older ones. In cases of conflicting overrides from different sources (e.g., automated systems or external APIs), a priority system may be implemented based on factors such as data freshness, relevance, and business logic rules defined for that particular flow.

In addition to these embodiments, the system also allows users to create custom templates or libraries by saving predefined shapes as reusable assets within a centralized repository accessible across multiple projects. This enables designers to build upon existing designs without having to recreate them from scratch each time they encounter similar data flows in different contexts.

When loading graphs from a database for visualization on client devices, the system can employ compression algorithms (e.g., JPEG2000) and techniques like progressive rendering and delta encoding to optimize transmission while maintaining visual fidelity. This ensures efficient transfer of graphical updates between clients without compromising image quality.

This process involves mapping the new input values onto their respective positions within the time period defined for that specific part of the graph. The augmented graphical curve then reflects these changes as it updates its visual representation on the GUI screen. In an embodiment, this system may employ interpolation algorithms to fill gaps in historical data or missing points along the original expected flow curves when loading graphs from storage devices. This ensures seamless continuity and accuracy across both modified and unmodified parts of the graph.

In another embodiment, multiple users may simultaneously attempt to update overridden expected flows within overlapping time periods; a conflict resolution mechanism can be employed to prioritize changes based on factors such as user role or timestamp of modification. In cases where input values are deemed invalid by predefined rules stored in memory, error messages guide users towards corrective actions and prevent data inconsistencies.

Furthermore, this system may be configured with various graphical shapes catering to different types of expected flows; these pre-defined templates include linear curves (e.g., straight lines), non-linear curves (e.g., sine waves), step functions, exponential growth models, sinusoidal patterns, or custom-designed representations for specific applications. Users may also create and save their own libraries of reusable assets within the system's centralized repository.

To optimize data transmission over computer networks while maintaining visual fidelity of graphically represented data, this embodiment employs compression algorithms (e.g., JPEG2000) to reduce image size without compromising quality; progressive rendering techniques are used for efficient transfer of graphical updates between client devices. Additionally, users may set up custom dashboards by grouping related graphs together and tailoring the visualization experience according to their needs or organizational structure.

In another embodiment, when loading augmented curves from storage devices, missing values may be handled through interpolation algorithms that maintain integrity across both original and modified parts of the graph; in cases where gaps are useful due to incomplete records, users may opt for default or estimated fill-in data. Furthermore, this system includes built-in analytics tools providing insights into trends and patterns present throughout expected flow curves.

In an embodiment, when multiple override requests conflict with each other (e.g., different users attempting to modify overlapping time periods), the system resolves these conflicts by prioritizing changes based on factors such as user role or timestamp of modification.

Upon user selection, the system generates a default graph based on their choice, which is then displayed for visualization on a GUI screen. The method further enables overriding specific data values within this expected flow by selecting individual time periods and entering new value(s), updating the augmented graphical curve accordingly to reflect changes made. To optimize transmission over computer networks while maintaining visual fidelity of graphic representations, compression algorithms such as JPEG2000 are employed for reducing image size without compromising quality.

Still further, in various embodiments, predefined shapes may be stored in memory as vector graphics or raster images depending on system architecture.

In various embodiments, users may input expected data flows using methods beyond defining over a set time period, including historical analysis of past trends and statistical modeling based on historical patterns.

In various embodiments, a default graph may be generated by mapping user selection from predefined graphical shapes to corresponding mathematical functions or algorithms that define those shapes.

In various embodiments, override values may be entered in various formats besides numerical input, such as text-based inputs (e.g., 50% increase) and date ranges; conversion of these alternative formats to numeric values are handled by system parsing algorithms.

In various embodiments, when multiple users attempt to update overridden expected data flows simultaneously over the same time period, a conflict resolution mechanism may be implemented based on user privilege level or timestamp.

In various embodiments, clients may receive override data values from sources besides user input, including automated systems and external APIs; these inputs integrate into overall graph updates accordingly.

In various embodiments, the one or more processors may handle missing values by interpolating between available data points to maintain integrity of graphical representations.

### Further Considerations

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although user operations of one or more methods are illustrated and described as separate operations, one or more of the user operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A cloud-based system for visualizing dynamically updated data flows, the cloud-based system comprising:
one or more processors accessible over a computer network;
one or more memories communicatively coupled with the one or more processors,
the one or more memories storing a set of predefined graphical shapes, each predefined graphic shape defining a graphical curve type of an expected data flow; and
computer executable instructions stored in the one or more memories that, when executed by the one or more processors, cause the one or more processors to:
input an expected data flow defined over a set time period;
generate a selection display depicting each of the predefined graphical shapes, the selection display configured for visualization on a graphic user interface (GUI) of a display screen of a client device;
receive a selection of a predefined graphical shape as selected from the predefined graphical shapes,
generate, based on the selection of the predefined graphical shape, a default graphical display depicting a default graphical curve having by a graphical curve type defined by each of: (a) the predefined graphical shape as selected, and (b) the data flow defined over the set time period, the default display configured for visualization on the GUI of the display screen of the client device,
receive a selection of a unit time period selected from within the set time period, the unit time period displayed on the default graphical display,
receive an override data value for overriding the expected data flow, the override data value defined for the unit time period as selected from within the set time period,
generate an overridden expected data flow defined over the set time period by updating the expected data flow with the override data value,
dynamically update the default graphical curve to create an augmented graphical curve defined by the overridden expected data flow,
generate, based on the augmented graphical curve, a dynamically updated graphical display depicting the augmented graphical curve having an updated portion visually depicting the overridden expected data flow over the set time period, and
transmit a reduced memory representation of the dynamically updated graphical display to the client device for visualization on the GUI of the display screen of the client device,
wherein the GUI of the display screen of the client device regenerates, from the reduced memory representation, the augmented graphical curve having an updated portion visually depicting the overridden expected data flow over the set time period.

2. The cloud-based system of claim 1, wherein the computer executable instructions, when executed by the one or more processors, further cause the one or more processors to:
transmits each of the selection display, the default display, and the dynamically updated graphical display to the client device over the computer network; and
receive each of the selection and the override data value from the client device over the computer network.

3. The cloud-based system of claim 1, wherein the computer executable instructions, when executed by the one or more processors, further cause the one or more processors to:
set as statically defined the override data value within overridden expected data flow defined over the set time period.

4. The cloud-based system of claim 3, wherein the computer executable instructions, when executed by the one or more processors, further cause the one or more processors to:
generate, as part of a display, a graphical element indicating that the override data value is a statically defined value within the overridden expected data flow.

5. The cloud-based system of claim 1, wherein the computer executable instructions, when executed by the one or more processors, further cause the one or more processors to:
convert the overridden expected data flow of the augmented graphical curve into a data flow graph having a converted curve data format,
store the data flow graph into a database,
load the data flow graph from the database, and
regenerate, based on the data flow graph from the database, the dynamically updated graphical display depicting the augmented graphical curve having the updated portion visually depicting the overridden expected data flow over the set time period, the dynamically updated graphical display configured for visualization on the GUI of the display screen of the client device.

6. The cloud-based system of claim 5, wherein the converted curve data format comprises a compressed data format stored in a single non-denormalized column of the database.

7. The cloud-based system of claim 1, wherein one or more portions of the expected data flow are received in a plurality of different formats when analyzed by the one or more processors, and the computer executable instructions, when executed by the one or more processors, further cause the one or more processors to:
convert the one or more portions of the expected data flow to a normalized format.

8. The cloud-based system of claim 7, wherein the normalized format comprises a JavaScript Object Notation (JSON) format.

9. The cloud-based system of claim 1, wherein upon or as part of generation of the overridden expected data flow, the computer executable instructions, when executed by the one or more processors, further cause the one or more processors to:
update one or more remaining data values other than the override data value within the overridden expected data flow defined over the set time period,
wherein the augmented graphical curve is created to graphically depict each of the override data value and the one or more remaining data values, each as updated in the overridden expected data flow as triggered by a change in the override data value.

10. A cloud-based method for visualizing dynamically updated data flows, the cloud-based method comprising:
inputting, by one or more processors accessible over a computer network, an expected data flow defined over a set time period;
generating, by the one or more processors, a selection display depicting each of a set of predefined graphical shapes, the selection display configured for visualization on a graphic user interface (GUI) of a display screen of a client device, each predefined graphic shape defining a graphical curve type of an expected data flow;
receiving, by the one or more processors, a selection of a predefined graphical shape as selected from the predefined graphical shapes;
generating, based on the selection of the predefined graphical shape by the one or more processors, a default graphical display depicting a default graphical curve having by a graphical curve type defined by each of: (a) the predefined graphical shape as selected, and (b) the data flow defined over the set time period, the default display configured for visualization on the GUI of the display screen of the client device;
receiving, by the one or more processors, a selection of a unit time period selected from within the set time period, the unit time period displayed on the default graphical display;
receiving, by the one or more processors, an override data value for overriding the expected data flow, the override data value defined for the unit time period as selected from within the set time period;
generating, by the one or more processors, an overridden expected data flow defined over the set time period by updating the expected data flow with the override data value;
dynamically updating, by the one or more processors, the default graphical curve to create an augmented graphical curve defined by the overridden expected data flow;
generating, based on the augmented graphical curve by the one or more processors, a dynamically updated graphical display depicting the augmented graphical curve having an updated portion visually depicting the overridden expected data flow over the set time period; and
transmit a reduced memory representation of the dynamically updated graphical display to the client device for visualization on the GUI of the display screen of the client device,
wherein the GUI of the display screen of the client device regenerates, from the reduced memory representation, the augmented graphical curve having an updated portion visually depicting the overridden expected data flow over the set time period.

11. The cloud-based method of claim 10 further comprising:
transmitting each of the selection display, the default display, and the dynamically updated graphical display to the client device over the computer network; and
receiving each of the selection and the override data value from the client device over the computer network.

12. The cloud-based method of claim 10 further comprising:
setting as statically defined the override data value within overridden expected data flow defined over the set time period.

13. The cloud-based method of claim 12 further comprising:
generating, as part of a display, a graphical element indicating that the override data value is a statically defined value within the overridden expected data flow.

14. The cloud-based method of claim 10 further comprising:
converting the overridden expected data flow of the augmented graphical curve into a data flow graph having a converted curve data format,
storing the data flow graph into a database;
loading the data flow graph from the database; and
regenerating, based on the data flow graph from the database, the dynamically updated graphical display depicting the augmented graphical curve having the updated portion visually depicting the overridden expected data flow over the set time period, the dynamically updated graphical display configured for visualization on the GUI of the display screen of the client device.

15. The cloud-based method of claim 14, wherein the converted curve data format comprises a compressed data format stored in a single non-denormalized column of the database.

16. The cloud-based method of claim 10, wherein one or more portions of the expected data flow are received in a plurality of different formats when analyzed by the one or more processors, and the cloud-based method further comprising:
converting the one or more portions of the expected data flow to a normalized format.

17. The cloud-based method of claim 16, wherein the normalized format comprises a JavaScript Object Notation (JSON) format.

18. The cloud-based method of claim 10 further comprising:
updating one or more remaining data values other than the override data value within the overridden expected data flow defined over the set time period,
wherein the augmented graphical curve is created to graphically depict each of the override data value and the one or more remaining data values, each as updated in the overridden expected data flow as triggered by a change in the override data value.

19. A tangible, non-transitory computer-readable medium storing instructions for visualizing dynamically updated data flows, that when executed by one or more processors cause the one or more processors to:
input, by one or more processors accessible over a computer network, an expected data flow defined over a set time period;
generate, by the one or more processors, a selection display depicting each of a set of predefined graphical shapes, the selection display configured for visualization on a graphic user interface (GUI) of a display screen of a client device, each predefined graphic shape defining a graphical curve type of an expected data flow;
receive, by the one or more processors, a selection of a predefined graphical shape as selected from the predefined graphical shapes;
generate, based on the selection of the predefined graphical shape by the one or more processors, a default graphical display depicting a default graphical curve having by a graphical curve type defined by each of: (a) the predefined graphical shape as selected, and (b) the data flow defined over the set time period, the default display configured for visualization on the GUI of the display screen of the client device;
receive, by the one or more processors, a selection of a unit time period selected from within the set time period, the unit time period displayed on the default graphical display;
receive, by the one or more processors, an override data value for overriding the expected data flow, the override data value defined for the unit time period as selected from within the set time period;
generate, by the one or more processors, an overridden expected data flow defined over the set time period by updating the expected data flow with the override data value;
dynamically update, by the one or more processors, the default graphical curve to create an augmented graphical curve defined by the overridden expected data flow;
generate, based on the augmented graphical curve by the one or more processors, a dynamically updated graphical display depicting the augmented graphical curve having an updated portion visually depicting the overridden expected data flow over the set time period; and
transmit a reduced memory representation of the dynamically updated graphical display to the client device for visualization on the GUI of the display screen of the client device,
wherein the GUI of the display screen of the client device regenerates, from the reduced memory representation, the augmented graphical curve having an updated portion visually depicting the overridden expected data flow over the set time period.
